(19) United States
(12) Patent Application Publication
(10) Pub. No.: US 2004/0109235 A1
(43) Pub. Date: Jun. 10, 2004

(54) Batched package process for creating optical blocks for use in forming optical components

(76) Inventors: Johnny Zhong, Union City, CA (US); Yin Zhang, San Jose, CA (US); Steve Wang, San Jose, CA (US); Kevin Zhang, Fremont, CA (US)

Correspondence Address: R. BURNS ISRAELSEN, WORKMAN HYDEGGER, 1000 Eagle Gate Tower, 60 East South Temple, Salt Lake City, UT, 84111, US

(21) Appl. No.: 10/724,428

(22) Filed: Nov. 26, 2003

Related U.S. Application Data
(60) Provisional application No. 60/429,255, filed on Nov. 26, 2002.
(60) Provisional application No. 60/429,467, filed on Nov. 26, 2002.

(51) Int. Cl. G02B 27/14; B23P 17/00

(52) U.S. Cl. 359/634; 29/412

(57) ABSTRACT

A batched process for producing optical components for use in fiber-optic networks. The process involves creating optical substrate blocks with thin-film filters on at least one surface of the of the substrate blocks. Other surfaces on the blocks are finely polished such the several blocks may be fused together at the polished surfaces. By placing the blocks such that the thin-film filters on adjacent blocks are diagonally opposed and then fusing together adjacent blocks, the blocks connected in this manner can perform various optical functions. Some of the optical components that can be formed using this process include power taps, optical add/drop modules, multiplexers, and demultiplexers.

### CROSS REFERENCE TO RELATED APPLICATION

This application claims the benefit of United States Provisional Application No. 60/429,255, titled OPTICAL ADD/DROP PATCH CORD and filed Nov. 26, 2002 and United States Provisional Application No. 60/429,467 titled A BATCHED PACKAGE PROCESS FOR CREATING OPTICAL BLOCKS FOR USE IN FORMING OPTICAL COMPONENTS and filed Nov. 26, 2002, which are incorporated herein by this reference.

### BACKGROUND OF THE INVENTION

1. The Field of the Invention

The invention generally relates to fabricating components for use in fiber-optic networks. More specifically, the invention relates to fabricating devices such as optical add/drop modules, multiplexers, and demultiplexers using optical blocks.

2. Description of the Related Art

One goal in modern networks, including fiber-optic networks, is to maximize the amount of data traffic that can be transmitted along a single optical fiber. One way of increasing the amount of data traffic is by using various types of multiplexing arrangements. One such multiplexing arrangement known as Wavelength Division Multiplexing (WDM) is based on sending multiple signals on different channels through the same optical fiber. Each channel uses a carrier beam with a different frequency or wavelength than the other carrier beams. For instance, in one arrangement known as coarse wavelength division multiplexing (CWDM), signals are sent using lasers with channel wavelengths varying between 1470 nm and 1610 nm in 20 nm increments. Each incremental wavelength corresponds to a different carrier beam or channel.

To accomplish a multiplexing arrangement such as the one described above, several specialized data handling components are needed. For example, to combine all of the different channels into one signal, a multiplexer (mux) is typically needed. A multiplexer essentially combines the various carrier beams or channels and propagates them onto the optical fiber. To decode the combined signal, a demultiplexer (demux) is needed to separate the multiplexed light signal into the different carrier beams associated with the respective channels. Often a combination component known commonly as a mux/demux is used by a particular device residing on a network to extract all of the network information associated with a particular multiplexed light signal such that it can be used by a device (such as a client computer) on the network and then re-multiplex the signal and return the signal to the fiber-optic network, such that the signal can be used by other devices on the network.

Sometimes it is desirable to extract a single beam or channel from the multiplexed signal. In this case, a drop module is used to extract the signal for the particular device that has need of the channel. To add the dropped channel back to the multiplexed signal, an add module is used. Commonly, a combination of these modules, an optical add/drop module, is used to extract a particular channel needed by a device, input the extracted channel into the device and then add the extracted signal back into the multiplexed signal, thereby preserving the channel for subsequent devices that have need for the data of the channel.

Yet another class of components used in typical optical networks is optical taps including power taps. A power tap extracts a percentage of the light associated with the optical signal propagating on the fiber-optic network, while allowing the remainder of the light to propagate further through the network.

These optical components are often implemented using conventional three or four port devices. One example of a three port device is a fused-fiber three port device. A fused-fiber three port device is formed by twisting two optical fibers around each other, heating the portions of the fibers that are twisted around each other, and stretching the heated portions until light traveling through the fused-fiber three port device behaves as desired. Portions of the fibers that have not been fused together are used as the inputs and outputs of the fused-fiber three port device. In this way, a three port device that directs a channel of a certain wavelength from an input signal into an output port can be created. Alternatively, a three port device that combines two signals into an output signal can be created. Various other devices may also be created.

Another class of three or four port devices is thin-film devices. Thin-film devices are created by forming a thin-film of some material on a glass substrate. Light passing through the three or four port device is refracted depending on the thickness of the film, the characteristics of the film (such as number of layers and the index of refraction of each layer) and the characteristics of the glass substrate. Optical fibers are used to transmit light signals into the thin-film devices. Refracted and un-refracted light may be collimated into other optical fibers by the thin-film devices. By combing a number of thin-film or fused-fiber devices, such as by interconnecting the various optical fibers connected to the thin-film devices in various arrangements, multiplexers, demultiplexers, optical add/drop modules, power taps and the like can be manufactured.

While optical components constructed from fused-fiber and thin-film fiber connected three and four port devices perform the various optical functions described above, their use can be complicated and cumbersome, because many discrete components must be used for the multiplexing and demultiplexing functions. A four port multiplexer, for example, may require four discrete three port components. The use of these optical components requires a relatively large number of interconnections between the optical fibers. Each interconnection between fibers causes an insertion loss, which is a loss of a portion of the light signal. Multiple interconnections leads to relatively high insertion loss in components implementing conventional fused-fiber and thin-film three and four port devices. Moreover, the use of these conventional components that require multiple three and four port devices is difficult when implementing the components in compact spaces.

### BRIEF SUMMARY OF THE INVENTION

One embodiment of the invention includes a method of fabricating optical components. The method includes obtaining a plurality of optical blocks. At least some of the optical blocks have thin-films on at least one face of the optical blocks. The optical blocks are arranged to permit optical signals to impinge at least some of the thin-films. The optical blocks are fused together to form an optical component.

Another embodiment of the invention includes an optical component. The optical component includes a number of optical blocks. Some or all of the optical blocks include a thin-film on at least one face of the optical blocks. The optical blocks are fused together to allow light to impinge at least a portion of the optical blocks.

Yet another embodiment of the invention includes a method of processing a multiplexed light signal. The method includes inputting a multiplexed light signal into a first optical block. At a thin-film on the first optical block, at least one channel of the multiplexed light signal is reflected towards a second optical block. At least one channel of the multiplexed light signal is allowed to pass through the thin-film disposed on the first optical block. The second optical block is fused with the first optical block. At a thin-film disposed on the second optical block, at least one channel of the multiplexed light signal is reflected.

Advantageously, some embodiments of the invention provide for an optical component that has reduced optical fiber interconnections resulting in reduced overall insertion losses. Some embodiments of the invention provide a batched packaging process whereby customized optical components can be constructed by selecting and fusing thin-film blocks with the appropriate characteristics.

These and other advantages and features of the present invention will become more fully apparent from the following description and appended claims, or may be learned by the practice of the invention as set forth hereinafter.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a process for making optical blocks where the blocks include at least one thin-film for use in a batched package process;

FIG. 2 illustrates a process for fabricating an optical add/drop module using a batched package process; and

FIG. 3 illustrates a process for fabricating a demultiplexer using a batched package process.

### DETAILED DESCRIPTION OF THE INVENTION

The present disclosure illustrates a method of manufacturing optical components using a batched package process. Components made by the batched package process described herein may be more efficient, more compact and less expensive than conventional components that perform similar functions.

A batched package process in one embodiment of the invention involves fabricating optical components using a plurality of optical blocks that have thin-films deposited or grown on at least one face of each optical block. The thin-films exhibit particular filtering characteristics that are used to achieve the optical functions described herein. The optical blocks are then finely polished on their attachment surfaces to substantially remove impurities or irregular surfaces. The optical blocks will adhere to other optical blocks simply by pressing a polished surface against the polished surface of another optical block. By fusing one or more optical blocks together, various optical components can be formed. The blocks naturally fuse because the attachment surfaces are highly polished. Exemplary optical components formed by these optical blocks include, but are not limited to, optical add/drop modules, optical multiplexers, optical demultiplexers, optical taps, optical add modules, optical drop modules, and the like or any combination thereof. An optical component's characteristics can be designed by selecting blocks with thin films with various optical properties and fusing them in an order to achieve a desired function.

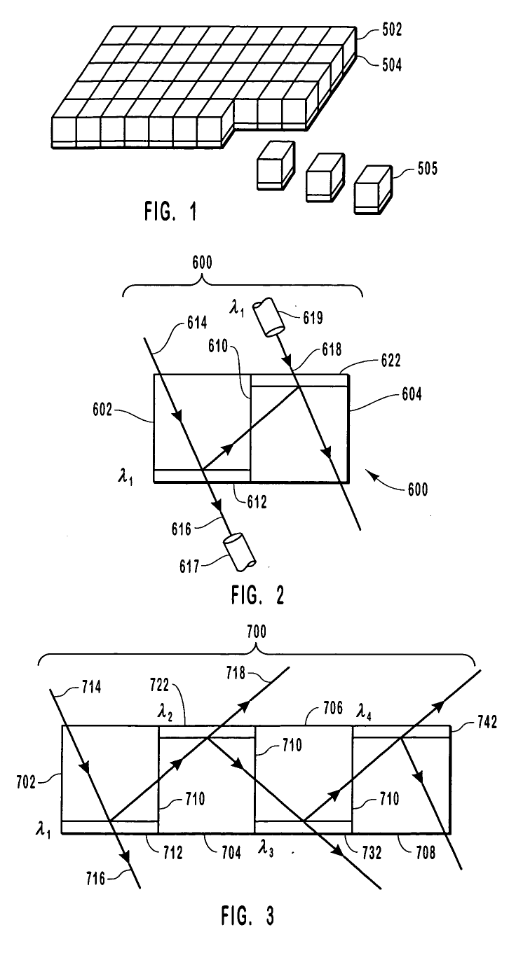

FIG. 1 generally illustrates one method for fabricating thin-film blocks to be used in the batched package process. The process of fabricating the blocks involves growing or depositing a thin-film 504 on one surface (hereinafter “the filter surface”) of the optical substrate 502. The thin-film 504 is a filter that exhibits a particular optical characteristic. For example, the thin-film 504 may be designed to reflect one or more specific wavelengths of light, while allowing one or more other wavelengths of light to pass through. Alternatively, the thin-film may be fabricated such that a certain percentage of light is passed through the thin-film, while the remaining portion of the light is reflected. The thin-film may also be fabricated such that one or more particular wavelengths are allowed to pass through the thin-film while substantially all other wavelengths are reflected. The optical substrate 502 with the thin-film 504 is then diced into blocks represented by the optical blocks 505. As used herein, the term “block” extends to any structure that can be diced from an optical substrate in the manner described herein.

One advantage of the present invention is that the different substrates can have different filters formed thereon and the resulting blocks can be combined to form optical components that include different thin-film filters. This enables, for example, multiplexing and demultiplexing functions to be performed by pressing and fusing together a particular combination of blocks as described below.

Referring now to FIG. 2, a method of constructing an add/drop module, designated generally as 600, using the batched package process is shown. The add/drop module is constructed from two blocks 602 and 604 that have been manufactured according to the process set forth and illustrated by FIG. 1. In this example, the thin-films 612 and 622 on the blocks 602 and 604 have optical properties that are substantially the same. In another embodiment, the thin-films 612 and 622 are different and have different optical properties. The attachment faces 610 of the blocks 602 and 604 are polished to substantially remove all irregularities and impurities such that the blocks 602 and 604 will adhere together naturally. In one embodiment, the block 602 is pressed together with the block 604. Before pressing the blocks together, the blocks 602 and 604 are arranged such that the thin-film 612 is diagonally opposed to the thin-film 622 as shown in FIG. 2. Arranging the blocks in this manner permits portions of a light signal to be reflected from the thin-film of a first block to the thin-film of the next block. Each thin-film is configured to act on the light signal in a particular manner. If, for example, a channel in the light signal is being dropped, then the thin-film is configured to let that channel pass through the thin-film while reflecting all other channels in the light signal. The blocks 602 and 604 are then pressed together at their attachment faces 610 such that the blocks fuse together at the attachment faces 610 of the blocks 602 and 604.

In one embodiment, a multiplexed light signal 614 is input into the block 602 of the add/drop module 600. The multiplexed light signal 614 travels towards the thin-film 612 disposed on the block 602. When the multiplexed light signal-614 contacts or impinges the thin-film 612, a single channel, for which the thin-film has been designed in this example, passes through the thin-film 612 and into a drop path 616. The channel that passes through the thin-film 612 can then be collimated or launched into an optical fiber 617. The remaining channels of the multiplexed light signal 614 are reflected to the block 604 towards the thin-film 622. When these channels contact the second thin-film 622 of the block 604, they are reflected to an output path. The add functionality is achieved by adding the dropped channel (or any other appropriate channel) back to the multiplexed light signal 614 through an add path 618. The channel added through the add path may be input through an optical fiber 619. Accordingly, the functionality of an optical add/drop module is accomplished. In this example, the thin-films 612 and 622 are the same, thus, the channel carried by the add path 618 will pass through the thin-film 622, as it passed through the thin-film 612, and combine with the multiplexed light signal 614.

In some embodiments of the invention, a single wavelength may be reflected by a thin-film in the optical component while multiple wavelengths are allowed to pass through the thin-film.

Referring now to FIG. 3, a demultiplexer formed using the batched package process is shown. While the demultiplexer of FIG. 3 is a four-channel demultiplexer, the principles of the invention can be used to construct demultiplexers for other numbers of channels. To construct the demultiplexer, four thin-film blocks with different wavelength characteristics are selected. In other words, the optical filter on each block is configured to reflect or pass a different wavelength or set of wavelengths. In this example, a thin-film block 702 may be fabricated such that it reflects all wavelengths of light except those of a first wavelength λ1. The thin-film 722 of the thin-film block 704 reflects all wavelengths except for a second wavelength λ2. The thin-film 732 of the thin-film block 706 reflects all wavelengths except for a third wavelength λ3. The thin-film 742 of the thin-film block 708 reflects all wavelengths except for a fourth wavelength λ4. The thin-film blocks have attachment faces 710 that are finely polished to substantially remove any irregularities as well as any contaminants on the attachment faces 710, as described above in reference to FIG. 2. The blocks are then arranged such that their thin-film surfaces 712, 722, 732, and are diagonally opposed to each other and such that their attachment faces 710 are facing each other. The thin-film blocks are then pressed together, such that the attachment faces fuse forming a demultiplexer optical component.

Functionally, when a multiplexed light signal having a plurality of channels defined by different carrier beam wavelengths is propagated into the demultiplexer 700, a demultiplexing function is accomplished. The multiplexed light signal 714 enters the thin-film block 702 and travels to the first thin-film 712. This thin-film surface reflects the entire light beam except for the channel having a wavelength λ1. The channel having wavelength λ1 is propagated into light path 716. This channel may then be used by any device for which the demultiplexing function is performed. The remaining portion of the multiplexed light signal 714 is reflected to the second thin-film block 704 and towards the thin-film 722. The thin-film 722 permits a wavelength λ2 be separated from the multiplexed light signal 714 while reflecting the remaining channels or wavelengths to the thin-film 732 of the third thin-film block 706. The light continues to propagate through the demultiplexer in this manner until all of the required channels have been extracted from the multiplexed light signal 714. In other words, the wavelength λ1 is separated or dropped by the block 702, the wavelength λ2 is separated or dropped by the block 704, the wavelength λ3 is dropped by the block 706, and the wavelength λ4 is dropped by the block 708.

A multiplexer device can be constructed in substantially the same was as described above in reference to the demultiplexer of FIG. 7. In one embodiment the multiplexer is operated by propagating the various channels of the multiplexed light signal through the thin-films from sources external to the multiplexer. Furthermore, a mux/demux can be constructed in a similar manner by combining the multiplexers and demultiplexers described herein. Other optical components, such as optical add/drop modules, taps, and the like can be similarly formed using the batched package process described herein. In other words, the optical blocks serve as blocks that can be arranged to perform certain optical functions. The blocks have attachment surfaces that adhere to each other thus permitting the various optical components to be formed. Another advantage is that blocks with different thin-film filters can be combined.

In one embodiment, a wafer is formed and coated with a thin-film and then diced into optical blocks or blocks. The next wafer is formed and coated with a different film and then diced into optical blocks or blocks. Additional thin-film blocks with various other types of films may be fabricated. In this manner, a large number of blocks with different filters can be readily available such that a desired optical component can be formed by selecting the appropriate blocks and pressing and fusing them together as described.

In one example, optical components are manufactured by obtaining a plurality of optical blocks where each block includes a thin-film filter and has one or more attachment faces. Next, the optical blocks are arranged such that the thin-film filter of each optical block is diagonally opposed to the thin-film filter of an adjacent optical block and such that the attachment faces on adjacent optical blocks are facing each other. Finally, the optical blocks are pressed together to form an optical component.

In another embodiment of the present invention, the optical blocks can be formed such that more than one surface has an optical filter. This would permit a particular configuration of blocks, for example, to function for light traveling in different directions. In addition, the blocks can be arranged in two or three dimensions to accomplish the optical functions. Also, blocks of different sizes and/or shapes can be connected or fused together. Further, while the examples set forth herein have shown arrangements where the thin-film filters on adjacent blocks are diagonally opposed, embodiments of the invention are not limited only to such an arrangement. For example, the thin-film filters may be perpendicular or at any other suitable angle or arrangement. Additionally, blocks without thin-films may be fused with blocks with thin-films. This may be done in one embodiment to adjust optical paths within the optical component. As such, fused and fusing as used herein does not require that the optical blocks be fused directly together, but denotes that optical blocks may be fused together through one or more intermediary optical blocks.

Additionally, the optical blocks may have different indices of refraction. This may be done, for example, to control the path of light traveling in the optical blocks.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of manufacturing optical components comprising:
selecting a plurality of optical blocks for an optical component, wherein at least a portion of the plurality of optical blocks have thin-films disposed on at least one face;
arranging the optical blocks to permit optical signals to impinge at least a portion of the thin-films, wherein an attachment face of each optical block is adjacent an attachment face of another optical block; and
fusing the plurality of optical blocks together where an attachment face is adjacent another attachment face to form an optical component.

2. The method of claim 1, wherein arranging the optical blocks to permit optical signals to impinge at least a portion of the thin-films comprises arranging the optical blocks such that a first thin-film on a first optical block is diagonally opposed to a second thin film on a second optical block.

3. The method of claim 1, further comprising forming the plurality of optical blocks by:
depositing a thin-film on a glass substrate; and
dicing the thin-film and glass substrate to form optical blocks that have thin-films on a least one face of each optical block.

4. The method of claim 1, wherein selecting a plurality of optical blocks for an optical component comprises:
growing a thin-film on glass substrate; and
dicing the thin-film and glass substrate to form optical blocks that have thin-films on at least one face of each optical block.

5. The method of claim 1, wherein fusing the plurality of optical blocks comprises:
polishing each of the optical blocks on at least one attachment face; and
pressing the attachment face of the each optical block to the attachment face on an adjacent optical block.

6. The method of claim 1, wherein the optical component is at least one of an optical add/drop module, an optical multiplexer, an optical demultiplexer, an optical tap, an optical add module and an optical drop module.

7. The method of claim 2, wherein the first thin film and the second thin film have substantially the same optical properties.

8. The method of claim 2, wherein the first thin film and the second thin film have different optical properties.

9. An optical component comprising:
a first optical block comprising:
a first thin-film on at least one face of the first optical block; and
a first attachment face;
a second optical block comprising:
a second thin-film on at least one face of the second optical block; and
a second attachment face that is fused to the first attachment face to allow light to impinge the first and second thin films.

10. The optical component of claim 9, wherein the first and second thin-films have the same optical properties.

11. The optical component of claim 9, wherein the first and second thin-films have different optical properties.

12. The optical component of claim 9, wherein at least one of the first and second thin-films is configured to allow a specified wavelength of light to pass through the thin-film while reflecting other wavelengths of light.

13. The optical component of claim 9, wherein at least one of the first and second thin-films is configured to reflect a specified wavelength of light while allowing other wavelengths of light to pass through the thin-film.

14. The optical component of claim 9, wherein at least one of the first and second thin-films is configured to reflect a plurality of wavelengths of light while allowing other wavelengths of light to pass through the thin-film.

15. The optical component of claim 9, wherein at least one of the first and second thin-films is configured to allow a plurality of wavelengths of light to pass through the thin-film while reflecting other wavelengths of light.

16. The optical component of claim 9, wherein the first and second thin-films are diagonally opposed to each other.

17. A method of processing a multiplexed light signal comprising:
arranging first and second optical blocks to allow the multiplexed light signal to pass through the first and second optical blocks;
fusing an attachment face of the first optical block with an attachment face of the second optical block;
inputting the multiplexed light signal into the first optical block;
at a first thin-film disposed on the first optical block, reflecting at least one channel of the multiplexed light signal toward the second optical block while allowing at least one channel of the multiplexed light signal to pass through the first thin-film disposed on the first optical block; and
at a second thin-film disposed on the second optical block, reflecting at least one channel of the multiplexed light signal.

18. The method of claim 17, further comprising collimating the at least one channel of the multiplexed light signal allowed to pass through the first thin-film on the first optical block into a first fiber-optic cable.

19. The method of claim 17, further comprising adding a channel at the second optical block to combine with the multiplexed light signal.

20. The method of claim 17, wherein the first optical block is fused to the second optical block via at least one intermediary optical block.

21. The method of claim 17, wherein reflecting at least one channel of the multiplexed light signal toward a second optical block comprises reflecting the at least one channel of the multiplexed signal in a direction diagonally opposed to the first thin-film disposed on the first optical block.

22. The method of claim 17, further comprising allowing at least one channel of the multiplexed light signal to pass through the second thin-film disposed on the second optical block.

23. A method of manufacturing an optical component comprising:
disposing a thin film on an optical substrate, the thin film having optical properties;
dicing the substrate to form optical blocks;
polishing attachment faces on the optical blocks; and
fusing the optical blocks at the attachment faces to form optical components having a function that is related to optical properties of the thin film disposed on the optical substrate.

24. The method of claim 23, wherein disposing a thin film on an optical substrate comprises growing the thin film on the optical substrate.

25. The method of claim 23, wherein disposing a thin film on an optical substrate comprises depositing the thin film on the optical substrate.

26. The method of claim 23, further comprising arranging the optical block such that thin films on the optical blocks are diagonally opposed to each other.

27. The method of claim 23, wherein the optical components are one of: optical add/drop modules;
optical multiplexers;
optical demultiplexers; and
optical taps.
